(19) United States
(12) Patent Application Publication
(10) Pub. No.: US 2026/0175418 A1
(43) Pub. Date: Jun. 25, 2026

(54) ROBOT LEARNING DATASET CONSTRUCTION METHOD, HUMANOID ROBOT, AND COMPUTER-READABLE STORAGE MEDIUM

(71) Applicant: UBTECH ROBOTICS CORP LTD, Shenzhen (CN)

(72) Inventors: Meng Yan, Shenzhen (CN); Pengpeng Xu, Shenzhen (CN); Jiajun Wu, Shenzhen (CN); Huaxi Zhang, Shenzhen (CN); Ying Ye, Shenzhen (CN); Wenlong Qin, Shenzhen (CN); Ligang Ge, Shenzhen (CN)

(21) Appl. No.: 19/426,066

(22) Filed: Dec. 19, 2025

(30) Foreign Application Priority Data
Dec. 23, 2024 (CN) 202411923327.6

(51) Int. Cl. B25J 9/16; B25J 13/08; B25J 19/02

(52) U.S. Cl. CPC B25J 9/163; B25J 9/1664; B25J 9/1689; B25J 9/1692; B25J 13/089; B25J 19/023

(57) ABSTRACT

A robot learning dataset construction method, a humanoid robot, and a computer-readable storage medium are provided. The method includes: a robot operator uses an inertial motion capturing device to remotely operate a humanoid robot to perform various operation tasks, construct a dataset by collecting real-time working images and real-time joint motion data of the humanoid robot performing various operation tasks under manual guidance, thereby utilizing the flexible combination of the human body posture direct extraction characteristics of the inertial motion capturing device and the flexibility and reliability of executing robot remote operation tasks so as to improve the construction efficiency, dataset validity, and dataset integrity of the task learning dataset, which facilitates further improvement of the generalization and accuracy of the imitation learning of the humanoid robot.

### CROSS REFERENCE TO RELATED APPLICATIONS

The present disclosure claims priority to Chinese Patent Application No. 202411923327.6, filed Dec. 23, 2024, which is hereby incorporated by reference herein as if set forth in its entirety.

### TECHNICAL FIELD

The present disclosure relates to humanoid robot technology, and particularly to a robot learning dataset construction method, a humanoid robot, and a computer-readable storage medium.

### BACKGROUND

With the continuous development of science and technology, humanoid robot technology has become more and more widely applicated in major industries. With the diversification of robot application scenarios, the working environment of humanoid robots has become more and more complex, and the motion control strategies designed for a single task cannot adapt to a large number of flexible and complex work scenarios, which will limit the further development of robot technology. For this reason, robot imitation learning technology can give humanoid robots the flexible operation ability to perform tasks in complex scenes, which is of great significance in realizing robot intelligence and autonomy, and has gradually become an important research topic in applying humanoid robots.

At present, in the practical applications of robot imitation learning technology, the quality and scale of task learning datasets directly affect the effect of the robot task execution control models learned through imitation. However, it is worth noting that the existing task learning datasets are mainly constructed by manually designing control algorithms to control humanoid robots to complete various tasks that interact with the environment, which is usually necessary to repeatedly debug the control algorithms to ensure the successful execution of the tasks, and is essentially difficult to quickly collect the task learning datasets required for the humanoid robots to learn through imitation while the validity and integrity of the datasets cannot be guaranteed.

### BRIEF DESCRIPTION OF DRAWINGS

To describe the technical schemes in the embodiments of the present disclosure or in the prior art more clearly, the following briefly introduces the drawings required for describing the embodiments or the prior art. It should be understood that, the drawings in the following description merely show some embodiments. For those skilled in the art, other drawings can be obtained according to the drawings without creative efforts.

FIG. 1 is a schematic diagram of the structure of a robot remote operation system according to an embodiment of the present disclosure.

FIG. 2 is a schematic diagram of the structure of a computing equipment according to an embodiment of the present disclosure.

FIG. 3 is a flow chart of the first part of a robot learning dataset construction method according to an embodiment of the present disclosure.

FIG. 4 is a schematic diagram of wearing an inertial motion capturing device on a robot remote operator for an upper body operation task according to an embodiment of the present disclosure.

FIG. 5 is a flow chart of sub-steps of step S220 in FIG. 3.

FIG. 6 is a flow chart of sub-steps of step S230 in FIG. 3.

FIG. 7 is a flow chart of the second part of the robot learning dataset construction method of FIG. 3.

### DETAILED DESCRIPTION

In order to make the objects, technical solutions and advantages of the embodiments of the present disclosure more clear, the technical solutions in the embodiments of the present disclosure will be clearly and completely described below with reference to the drawings in the embodiments of the present disclosure. Apparently, the described embodiments are part of the embodiments of the present disclosure, not all of the embodiments. The components of the embodiments of the present disclosure that are described and illustrated in the drawings herein may generally be arranged and designed in a variety of different configurations.

Therefore, the following detailed description of the embodiments of the present disclosure provided in the drawings is not intended to limit the scope of the present disclosure, but merely represent the selected embodiments of the present disclosure. Based on the embodiments in the present disclosure, all other embodiments obtained by those of ordinary skill in the art without creative work fall within the protection scope of the present disclosure.

It should be noted that, in the following figures, similar numerals and letters refer to similar items. Therefore, once an item is defined in one figure, it does not require further definition and explanation in subsequent figures.

In the description of the present disclosure, it is to be understood that the orientational or positional relationship indicated by the terms “center”, “upper”, “lower”, “left”, “right”, “vertical”, “horizontal”, “inner”, “outer”, or the like is based on the orientational or positional relationship shown in the drawings, that in the usual placement of the product related to the present disclosure, or that commonly understood by those skilled in the art, and is merely for the convenience of describing the present disclosure and simplifying the description, rather than indicating or implying that the device or component referred to must have a particular orientation, be constructed and operated in a particular orientation, hence should not be understood as limitations to the present disclosure.

In the description of the present disclosure, it should also be noted that, unless otherwise clearly stated and limited, the terms “set”, “install”, “link”, and “connect” should be comprehended in a broad sense. For example, it may be a fixed connection, a detachable connection, or an integral connection; it may be a mechanical connection, or be an electrical connection; it may be a direct connection, or be an indirect connection through an intermediate medium; or it may be an internal connection between two elements. For those ordinary skilled in the art, the specific meanings of the foregoing terms in the present disclosure can be understood on a case-by-case basis.

Furthermore, in the description of the present disclosure, it should be noted that, the relational terms such as “first” and “second” are used only to distinguish one entity or operation from another entity or operation, and do not necessarily require or imply the existence of any actual relationship or sequence between these entities or operations. Moreover, the terms “comprising”, “including” or any other variation thereof are intended to encompass non-exclusive inclusion such that a process, method, article or apparatus (device) comprising a series of elements includes not only those elements, but also includes other elements not explicitly listed or inherent to the process, method, article or apparatus. Without further limitation, an element limited by the sentence “comprising a . . . ” does not preclude the existence of additional identical elements in a process, method, article or apparatus that includes the element. For those of ordinary skill in the art, the specific meanings of the above-mentioned terms in the present disclosure can be understood according to the specific condition.

Some embodiments of the present disclosure will be described in detail below with reference to the drawings. The following embodiments and the features therein may be combined with each other while there is no confliction therebetween.

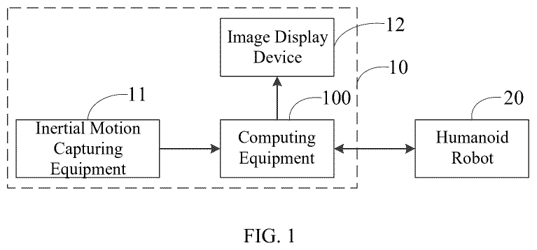

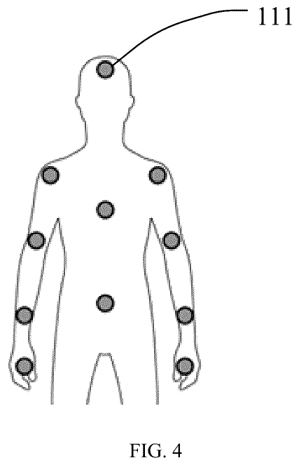

FIG. 1 is a schematic diagram of the structure of a robot remote operation system 10 according to an embodiment of the present disclosure. As shown in FIG. 1, in this embodiment, the robot remote operation system 10 may include an inertial motion capturing device 11 and a computing equipment 100. In which, the computing equipment 100 communicates with a humanoid robot 20 and the inertial motion capturing device 11, respectively. The inertial motion capturing device 11 is a wearable suit that includes a plurality of inertial posture sensors 111 (see FIG. 4) to respectively track motions of different human parts, such as a head, shoulders, upper arms, forearms, palms, back spines, waist hips, thighs, shins, feet, and the like of a robot remote operator. The computing equipment 100 may perform synchronized adjustments on the robot motion postures of the humanoid robot 20 based on the data of the human body motion postures monitored in real time by the inertial motion capturing device 11, so that the humanoid robot 20 can perform various operation tasks correspondingly under the robot remote operations (e.g., goods picking and goods assembling) performed by the robot remote operator.

In this embodiment, the computing equipment 100 may be an electronic device (e.g., a personal computer or a notebook computer) having an image display unit. The computing equipment 100 may obtain the real-time images captured for each task target (e.g., “to-be-grabbed objective” corresponding to “grabbing operation task”, “placement location for an item categories” corresponding to “sorting operation task”, the “ to-be-welded workpiece” corresponding to the “welding operation task”, and “ to-be-driven balancing vehicle” corresponding to “balancing vehicle driving operation task”) of the humanoid robot 20 that are related to the operating environment (e.g., a scene before a shelf in a factory) of the humanoid robot 20 for each operation task (e.g., a goods picking task) of the humanoid robot 20, and use the image display unit to display the real-time images so as to guide the robot remote operator to adjust his or her human body motion posture in time to ensure that the corresponding operation task can be successfully executed as soon as possible. In which, the humanoid robot 20 includes movable body parts like a head, wrists and knees, where at least one camera may be installed on the head to capture real-time images (i.e., image data) of the operating environment and the corresponding operation task of the humanoid robot 20 through the camera. In addition, the humanoid robot 20 may also be installed with at least one additional camera on the wrist and/or the knee of the humanoid robot 20 to assist the camera at the head to capture the real-time images, thereby ensuring that the image data obtained and displayed by the computing equipment 100 can reveal more details of task execution.

In other embodiments, the computing equipment 100 may also be an electronic device (e.g., a server) without the image display unit, and the robot remote operation system 10 may further include an image display device 12. The image display device 12 is deployed in front of the robot remote operator and communicates with the computing equipment 100 to display the real-time images obtained by the computing equipment 100 from the humanoid robot 20, thereby guiding the robot remote operator to adjust his or her human body motion posture in time to ensure that the corresponding operation task can be successfully executed as soon as possible.

In this embodiment, the computing equipment 100 may construct a dataset by collecting real-time working images and real-time joint motion data of the humanoid robot 20 performing various operation tasks under manual guidance during the robot remote operator uses the inertial motion capturing device 11 to remotely operate the humanoid robot 20 to perform various operation tasks, thereby utilizing the flexible combination of the human body posture direct extraction characteristics of the inertial motion capturing device 11 and the flexibility and the reliability of executing robot remote operation tasks so as to effectively improve the construction efficiency, dataset validity, and dataset integrity of the task learning dataset suitable for the humanoid robot 20, which facilitates further improvement of the generalization and accuracy of the imitation learning of the humanoid robot.

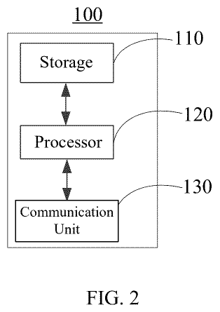

FIG. 2 is a schematic diagram of the structure of a computing equipment 100 according to an embodiment of the present disclosure. As shown in FIG. 2, in this embodiment, the computing equipment 100 is communicatively connect to the humanoid robot 20 and the inertial motion capture apparatus 11, respectively. The computing equipment 100 may include a storage 110, a processor 120, and a communication unit 130. In which, the storage 110, the processor 120, and the communication unit 130 are directly or indirectly connected to each other in electrical manner to implement the transmission or interaction of data. For example, the storage 110, the processor 120, and the communication unit 130 may be electrically connected to each other through one or more communication buses.

In this embodiment, the storage 110 may be, but not limited to, a random access memory (RAM), a read only memory (ROM), a programmable read only memory (PROM), erasable programmable read-Only memory (EPROM), electrical erasable programmable read-only memory (EEPROM), or the like. In which, the storage 110 is configured to store computer programs, and the processor 120 can execute the computer programs correspondingly after receiving execution instructions.

In this embodiment, the processor 120 may be an integrated circuit chip with signal processing capability. The processor 120 may be a general purpose processor including at least one of a central processing unit (CPU), a graphics processing unit (GPU), a network processor (NP), a digital signal processor (DSP), an application specific integrated circuit (ASIC), a field-programmable gate array (FPGA) or other programmable logic devices, discrete gate, transistor logic device, and discrete hardware component. In which, the general purpose processor may be a microprocessor or the processor may also be any conventional processor that may implement or execute the methods, steps, and the logical block diagrams disclosed in the embodiments of the present disclosure.

In this embodiment, the communication unit 130 is configured to establish a communicational connection between the computing equipment 100 and other electronic devices through a network, and to send and receive data through the network, where the network includes a wired communication network and a wireless communication network. For example, the computing equipment 100 may communicate with the image display device 12 through the communication unit 130 so as to display the specific task execution details of various operation tasks to the robot remote operator through the image display device 12, thereby facilitating the robot remote operator to adjust his or her human body motion posture in time so as to remotely operate the humanoid robot 20 to successfully perform the corresponding operation tasks as soon as possible.

In this embodiment, the computing equipment 100 may store a specific computer program of the functions related to constructing a robot learning dataset in the storage 110 in advance, and drive the processor 120 to correspondingly execute the specific computer program stored by the storage 110, thereby collecting real-time working images and real-time joint motion data of the humanoid robot 20 performing operation tasks under manual guidance while ensuring that the robot remote operator can perform various operation tasks using the inertial motion capturing device 11, which effectively improves the construction efficiency, dataset validity, and dataset integrity of the task learning dataset, which facilitates further improvement of the generalization and accuracy of the imitation learning of the humanoid robot

It should be noted that the block diagram shown in FIG. 2 is only an example of structure of the computing equipment 100, which may further include more or fewer components than that shown in FIG. 2, or have a different configuration from that shown in FIG. 2. Each of the components shown in FIG. 2 may be implemented in hardware, software or a combination thereof.

In the present disclosure, in order to ensure that the computing equipment 100 can quickly construct a task learning dataset with strong validity and integrity for the humanoid robot 20 while ensuring that the robot remote operator can remote control the humanoid robot 20 to perform various operation tasks using the inertial motion capturing device 11, thereby improving the generalization and accuracy of the imitation learning of the humanoid robot, a robot learning dataset construction method is provided. The robot learning dataset construction method provided by the present disclosure will be described in detail below.

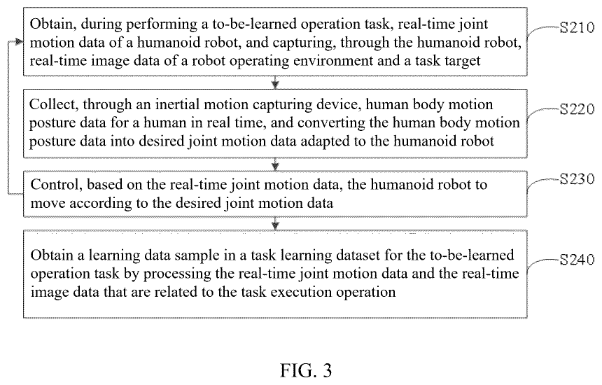

FIG. 3 is a flow chart of the first part of a robot learning dataset construction method according to an embodiment of the present disclosure. In this embodiment, the robot learning dataset construction method may be applied to (a processor of) the humanoid robot. In other embodiments, the method may be implemented through the computing equipment 100 in FIG. 2 or an inertial motion capturing device as shown in FIG. 4. As shown in FIG. 3, the robot learning dataset construction method may include steps S210-S240.

S210: obtaining, during performing a to-be-learned operation task, real-time joint motion data of the humanoid robot, and capturing, through the humanoid robot, real-time image data of a robot operating environment and a task target.

In this embodiment, the to-be-learned operation task is any operation task that requires imitation learning. The to-be-learned operation task may be an upper body operation task that only involves the upper body of the humanoid robot (e.g., grabbing operation task, sorting operation task, or welding operation task), a lower body operation task that only involves the lower body of the humanoid robot (e.g., balancing vehicle driving operation task, jumping over obstacle operation task), or a full-body collaborative operation task that involves the whole body of the humanoid robot (e.g., bicycle driving operation task or climbing operation task). The task target is the objective of the corresponding to-be-learned operation task, where different to-be-learned operation tasks correspond to different task targets. The task targets involved by the same type of to-be-learned operation tasks in different performing of the tasks may be the same, or be different from each other.

In this embodiment, the real-time joint motion data of the humanoid robot 20 may include the actual joint motion data of each of the movable body parts of the humanoid robot 20 in the corresponding body workspace coordinate system. The actual joint motion data of each movable body part includes actual joint position, actual joint angle, actual joint angular velocity, actual joint angular acceleration, actual joint moment, and other joint data under the body workspace coordinate system corresponding to each of the joints involved by the movable body part. In which, the composition of the movable body parts of the humanoid robot 20 matches the structural condition of the humanoid robot 20, where each movable body part corresponds to one body workspace coordinate system that can move independently move with respect to other movable body parts. For example, the movable body parts of the humanoid robot 20 may be composed of a robot head, a left robotic arm, a right robotic arm, a left robotic hand, a right robotic hand, and a lower limb structure, where the joints of the robot head include head joints, that of the left robotic arm and the right robotic arm include shoulder joints, elbow joints, and wrist joints, that of the left robotic hand and the right robotic hand include finger joints or gripper joints, and that of the lower limb structure include hip joints, knee joints, ankle joints, and the like.

In this embodiment, each to-be-learned operation task corresponds to one task execution initial posture. For each type of to-be-learned operation tasks, before each performing of a to-be-learned operation task, it needs to perform a device initialization (including synchronizing the internal clocks of each component included in the humanoid robot 20) on the humanoid robot 20, so that the humanoid robot 20 maintains the task execution initial posture corresponding to the to-be-learned operation task. At the same time, the robot remote operator also needs to maintain the task execution initial posture corresponding to the to-be-learned operation task to eliminate the wearing error of the inertial motion capturing device 11 on the robot remote operator, and then the robot remote operator can remotely operate the humanoid robot 20 to perform the to-be-learned operation task by adjusting human posture.

S220: collecting, through an inertial motion capturing device, human body motion posture data for a human in real time, and converting the human body motion posture data into desired joint motion data adapted to the humanoid robot.

In this embodiment, the inertial motion capturing device 11 may include a plurality of inertial posture sensors worn on different human skeletal parts of the robot remote operator, where the position of wearing the inertial posture sensors of the inertial motion capturing device 11 is related to the type of the to-be-learned operation task. FIG. 4 is a schematic diagram of wearing an inertial motion capturing device on a robot remote operator for an upper body operation task according to an embodiment of the present disclosure. As shown in FIG. 4, taking an upper body operation task as an example, the eleven inertial posture sensors (represented by circles) included in the inertial motion capturing device 11 are worn on the upper body of the human at the head, the shoulders, the upper arms, the forearms, the palms, the back spines, and the waist hips. At this time, the human body motion posture data collected by the inertial motion capturing device 11 will include skeletal motion posture data collected by the inertial posture sensors in a motion capture coordinate system.

In this embodiment, after obtaining the human body motion posture data of the robot remote operator in one performing of the to-be-learned operation task, the computing equipment 100 will map the human body motion posture data to a robot coordinate system of the humanoid robot 20 so as to obtain the desired joint motion data that the robot remote operator expects the humanoid robot 20 to use, thereby ensuring that the humanoid robot 20 and the robot remote operator can achieve the synchronization of motion postures through the desired joint motion data.

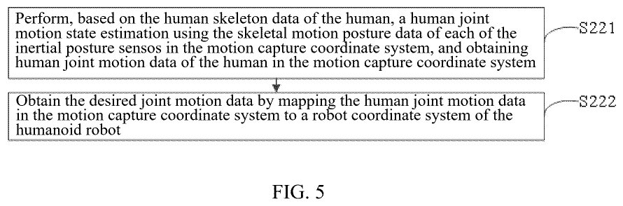

FIG. 5 is a flow chart of sub-steps of step S220 in FIG. 3. As shown in FIG. 5, in this embodiment, the “converting the human body motion posture data into desired joint motion data adapted to the humanoid robot” in step S220 may include sub-steps S221-S222 which convert the human body motion posture data of the robot remote operator into the desired joint motion data that can be used by the humanoid robot 20.

S221: performing, based on the human skeleton data of the human, a human joint motion state estimation using the skeletal motion posture data of each of the inertial posture sensos in the motion capture coordinate system, and obtaining human joint motion data of the human in the motion capture coordinate system.

In this embodiment, each inertial posture sensor included in the inertial motion capturing device 11 may be equipped with a highly dynamic three-axis accelerometer, a three-axis gyroscope, and a three-axis magnetometer. In this case, on the basis of the human skeleton data of the robot remote operator (including the bone lengths of various human body bones of the robot remote operator, the motion transfer relationships between the various human body bones, and the like), the computing equipment 100 may use a nine-axis data fusion algorithm and the Kalman filter algorithm to estimate human body joint poses (i.e., positions and postures) based on the skeletal motion posture data collected by each of the inertial posture sensors, thereby obtaining the human joint motion data of the robot remote operator (including human joint position, human joint angle, human joint angular velocity, human joint angular acceleration, human joint moment, and other joint data in the motion capture coordinate system of each of the joints of the robot remote operator that are related to the to-be-learned operation task) in the motion capture coordinate system.

S222: obtaining the desired joint motion data by mapping the human joint motion data in the motion capture coordinate system to a robot coordinate system of the humanoid robot.

In this embodiment, the robot coordinate system of the humanoid robot 20 may include the body workspace coordinate system of each of the movable body parts of the humanoid robot 20. In this case, the computing equipment 100 may classify the human joint motion data according to the composition of the movable body parts of the humanoid robot 20, and map the human joint motion data corresponding to different movable body parts to the corresponding body workspace coordinate system, thereby obtaining the desired joint motion data related to each of the movable body parts. At this time, the desired joint motion data adapted to the humanoid robot 20 may essentially include target joint motion data (including target joint position, target joint angle, target joint angular velocity, target joint angular acceleration, target joint moment, and other joint data in the corresponding body workspace coordinate system of each of the joints involved by the corresponding movable body part) of each of the movable body parts of the humanoid robot 20 in the corresponding body workspace coordinate system.

In this case, sub-step S222 may include: extracting, for each of the movable body parts, effective joint motion data corresponding to the movable body part from the human joint motion data; and obtaining the target joint motion data of each of the movable body parts in the corresponding body workspace coordinate system by performing, based on a coordinate system transformation relationship between the motion capture coordinate system and the body workspace coordinate system of the movable body part, a coordinate system transformation on the effective joint motion data corresponding to the movable body part. In which, for a single movable body part, the effective joint motion data corresponding to the movable body part includes joint data of each of the joints associated with the movable body part in the motion capture coordinate system.

Therefore, in this embodiment, the human body motion posture data of the robot remote operator can be converted into the desired joint motion data that can be used by the humanoid robot 20 through executing the above-mentioned sub-steps S221-S222.

S230: controlling, based on the real-time joint motion data, the humanoid robot to move according to the desired joint motion data, and returning to obtain the real-time joint motion data of the humanoid robot until the humanoid robot successfully completes a task execution operation for the task target.

In this embodiment, after obtaining the desired joint motion data of the humanoid robot 20 that is synchronized with the posture of the robot remote operator, the computing equipment 100 will generate an adapted motion control instruction for the humanoid robot 20 based on the real-time joint motion data of the humanoid robot 20, and then transmit the motion control instruction to the humanoid robot 20 for execution, thereby driving the humanoid robot 20 to change the robot motion posture represented by the real-time joint motion data changes to that represented by the desired joint motion data. At the same time, the computing equipment 100 will also return to the foregoing step S210 to continue execution until the humanoid robot 20 successfully completes one task execution operation of the to-be-learned operation task for the task target under the manual guidance of the robot remote operator.

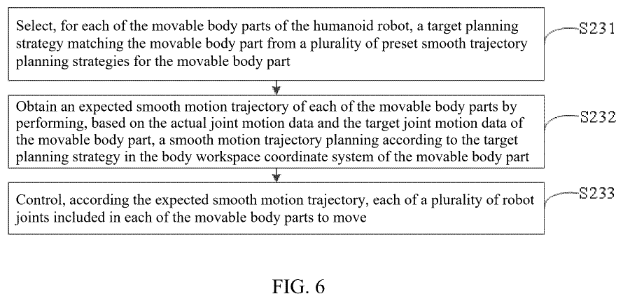

FIG. 6 is a flow chart of sub-steps of step S230 in FIG. 3. As shown in FIG. 6, in this embodiment, the real-time joint motion data of the humanoid robot 20 may include actual joint motion data of each of the movable body parts of the humanoid robot 20 in the corresponding body workspace coordinate system, and the desired joint motion data adaptable to the humanoid robot 20 may include the target joint motion data of each of the movable body parts in the corresponding body workspace coordinate system. In this case, the step S230 may include sub-steps S231-233 to realize the smooth motion control effect in different workspaces of the humanoid robot 20.

S231: selecting, for each of the movable body parts of the humanoid robot, a target planning strategy matching the movable body part from a plurality of preset smooth trajectory planning strategies for the movable body part.

In this embodiment, the smooth trajectory planning strategies for different movable body parts may be exactly the same, partially the same, or completely different. For example, for an upper body operation task, the movable body parts involved may be the robot head, the left robotic arm, the right robotic arm, the left robotic hand, and the right robotic hand, where the left robotic arm and the right robotic arm have their own smooth trajectory planning strategies, respectively. In which, the smooth trajectory planning strategy adopted by both of the left robotic arm and the right robotic arm may be a quintic spline interpolation trajectory planning algorithm; the smooth trajectory planning strategy adopted by the left robotic hand and the right robotic hand may be the quintic spline interpolation trajectory planning algorithm or a linear interpolation trajectory planning algorithm, respectively; and the smooth trajectory planning strategy adopted by the robot head may be the quintic spline interpolation trajectory planning algorithm or the linear interpolation trajectory planning algorithm.

S232: obtaining an expected smooth motion trajectory of each of the movable body parts by performing, based on the actual joint motion data and the target joint motion data of the movable body part, a smooth motion trajectory planning according to the target planning strategy in the body workspace coordinate system of the movable body part.

S233: controlling, according the expected smooth motion trajectory, each of a plurality of robot joints included in each of the movable body parts to move.

In this embodiment, the smoothing motion control effect in different workspaces can be implemented on the humanoid robot 20 through executing the above-mentioned sub-steps S231-S233.

S240: obtaining a learning data sample in a task learning dataset for the to-be-learned operation task by processing the real-time joint motion data and the real-time image data that are related to the task execution operation.

In this embodiment, each task learning dataset only corresponds to one to-be-learned operation task, and different learning data samples in the same task learning dataset respectively correspond to one task execution operation of the to-be-learned operation task. As for any learning data sample corresponding to the to-be-learned operation task, learning data samples implemented in HDF5 format can be obtained by performing data sorting on all the real-time joint motion data and image data related to the corresponding task execution operation in time dimension. The computing equipment 100 may perform the foregoing steps S210-S240 multiple times for the same to-be-learned operation task to construct the task learning dataset that matches the to-be-learned operation task.

In one embodiment, in order to avoid retaining a large amount of unnecessary data related to unnecessary human body motion postures of the robot remote operator in the constructed learning data sample, step S240 may include sub-steps of: obtaining a learning data sample of the to-be-learned operation task by constructing a time series for the robot joint sampling data and the observation image sampling data of each of the sampling moments.

In this embodiment, it can ensure that the constructed learning data sample can retain as little unnecessary data related to unnecessary human body motion postures as possible by executing the sub-steps of the above-mentioned step S240, thereby improving the effectiveness of the task learning dataset, as well as the generalization and accuracy of the imitation learning of the humanoid robot.

In this embodiment, by executing the above-mentioned steps S210-S240, it can ensure that a task learning dataset with strong validity and integrity for the humanoid robot 20 can be quickly constructed while ensuring that the robot remote operator can remote control the humanoid robot 20 to perform various operation tasks using the inertial motion capturing device 11, thereby improving the generalization and accuracy of the imitation learning of the humanoid robot.

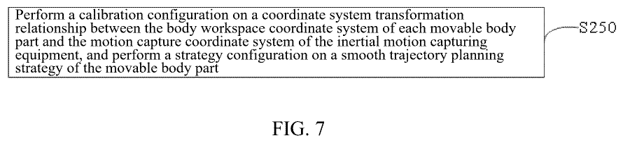

FIG. 7 is a flow chart of the second part of the robot learning dataset construction method of FIG. 3. As shown in FIG. 7, in this embodiment, compared with the robot learning dataset construction method shown in FIG. 3, it may further include step S250.

S250: performing a calibration configuration on a coordinate system transformation relationship between the body workspace coordinate system of each of a plurality of movable body parts of the humanoid robot and the motion capture coordinate system of the inertial motion capturing device, and performing a strategy configuration on a smooth trajectory planning strategy of the movable body part.

In this embodiment, with the difference in the structural conditions of the humanoid robot 20, there are also partial differences in the composition of the movable body parts of the humanoid robot 20. For example, the humanoid robot 20 with a waist joint has one more movable body part called “robot waist” than the humanoid robot 20 without the waist joint. Therefore, the task learning dataset constructed by the computing equipment 100 needs to be adapted to the structural conditions of the humanoid robot 20, and before constructing the learning dataset, the computing equipment 100 needs to first construct the structural conditions of the humanoid robot 20 of the learning dataset according to the actual requirements, and establish a coordinate system transformation relationship between the body workspace coordinate system of each of the movable body parts of the humanoid robot 20 and the motion capture coordinate system of the inertial motion capturing device 11, while obtaining and saving the smooth trajectory planning strategies configured by the robot remote operator for the movable body parts of the humanoid robot 20, thereby ensuring that any learning dataset finally constructed is adapted to the structural conditions of the humanoid robot 20.

In this embodiment, it can ensure that any learning dataset finally constructed can be adapted to the structural conditions of the humanoid robot 20 through executing the above-mentioned step S250.

In the embodiments of the present disclosure, it should be understood that the disclosed method and apparatus may be implemented in other manners. The above-mentioned apparatus embodiment is merely illustrative, for example, the flow charts and block diagrams in the drawings show the architecture, functions and operations that are possible to be implemented by the apparatus, method and computer program products of the embodiments. In this regard, each block in the flowchart or block diagram may represent a module, a program segment, or a part of codes that include one or more computer executable instructions for implementing specified logical functions. It should also be noted that, in some alternative implementations, the functions noted in the blocks may occur out of the order noted in the figures. For example, two blocks in succession may, in fact, be executed substantially concurrently, or may sometimes be executed in the reverse order, depending upon the functionality involved. It is also to be noted that each block in the block diagrams and/or flow charts, and the combination of blocks in the block diagrams and/or flow charts, may be implemented by a dedicated hardware-based system for performing the specified function or action, or may be implemented by a combination of special purpose hardware and computer instructions.

In addition, each functional module in each embodiment of the present disclosure may be integrated to form an independent part, each module or unit may exist independently, or two or more modules or units may be integrated to form an independent part. Each function can be stored in a computer readable storage medium if it is implemented in the form of a software functional unit and sold or utilized as a separate product. Based on this understanding, the technical solution of the present disclosure, either essentially or in part, contributes to the prior art, or a part of the technical solution can be embodied in the form of a software product. The software product is stored in a storage medium, which includes a number of instructions for enabling a computing equipment (which can be a personal computer, a server, a network device, etc.) to execute all or a part of the steps of the methods described in each of the embodiments of the present disclosure. The above-mentioned storage medium includes a variety of media such as a USB disk, a mobile hard disk, a read-only memory (ROM), a random access memory (RAM), a magnetic disk, and an optical disk which is capable of storing program codes.

The forgoing is only various embodiment of the present disclosure, while the scope of the present disclosure is not limited thereto. For those skilled in the art, modifications or replacements that can be easily conceived within the technical scope of the present disclosure should be included within the scope of the present disclosure.

What is claimed is:

1. A method for constructing learning dataset for a humanoid robot, comprising:
obtaining, during performing a to-be-learned operation task, real-time joint motion data of the humanoid robot, capturing, through a camera of the humanoid robot, real-time image data of a task target and a scene of the humanoid robot, and displaying the image data;
collecting, through an inertial motion capturing device, human body motion posture data for a human in real time, and converting the human body motion posture data into desired joint motion data adapted to the humanoid robot;
controlling, based on the real-time joint motion data, the humanoid robot to move according to the desired joint motion data, and returning to obtain the real-time joint motion data of the humanoid robot until the humanoid robot successfully completes a task execution operation for the task target; and
obtaining a learning data sample in a task learning dataset for the to-be-learned operation task by processing the real-time joint motion data and the real-time image data that are related to the task execution operation, wherein each learning data sample corresponds to each task execution operation of the to-be-learned operation task.

2. The method of claim 1, wherein the inertial motion capturing device includes a plurality of inertial posture sensors respectively worn on different human skeletal parts of the human, and the human body motion posture data includes skeletal motion posture data collected by the inertial posture sensors in a motion capture coordinate system; and converting the human body motion posture data into the desired joint motion data adapted to the humanoid robot comprises:
performing, based on the human skeleton data of the human, a human joint motion state estimation using the skeletal motion posture data of each of the inertial posture sensos in the motion capture coordinate system, and obtaining human joint motion data of the human in the motion capture coordinate system;
obtaining the desired joint motion data by mapping the human joint motion data in the motion capture coordinate system to a robot coordinate system of the humanoid robot.

3. The method of claim 2, wherein the robot coordinate system of the humanoid robot includes a body workspace coordinate system of each of a plurality of movable body parts of the humanoid robot, and the desired joint motion data includes target joint motion data of the movable body part in the corresponding body workspace coordinate system; and obtaining the desired joint motion data by mapping the human joint motion data in the motion capture coordinate system to a robot coordinate system of the humanoid robot comprises:
extracting, for each of the movable body parts, effective joint motion data corresponding to the movable body part from the human joint motion data; and
obtaining the target joint motion data of each of the movable body parts in the corresponding body workspace coordinate system by performing, based on a coordinate system transformation relationship between the motion capture coordinate system and the body workspace coordinate system of the movable body part, a coordinate system transformation on the effective joint motion data corresponding to the movable body part.

4. The method of claim 3, wherein the real-time joint motion data includes actual joint motion data of each of the movable body parts in the corresponding body workspace coordinate system; and controlling, based on the real-time joint motion data, the humanoid robot to move according to the desired joint motion data comprises:
selecting, for each of the movable body parts of the humanoid robot, a target planning strategy matching the movable body part from a plurality of preset smooth trajectory planning strategies for the movable body part;
obtaining an expected smooth motion trajectory of each of the movable body parts by performing, based on the actual joint motion data and the target joint motion data of the movable body part, a smooth motion trajectory planning according to the target planning strategy in the body workspace coordinate system of the movable body part; and
controlling, according the expected smooth motion trajectory, each of a plurality of robot joints included in each of the movable body parts to move.

5. The method of claim 1, wherein obtaining the learning data sample in the task learning dataset for the to-be-learned operation task by processing the real-time joint motion data and the real-time image data that are related to the task execution operation comprises:
obtaining robot joint sampling data and observation image sampling data of a plurality of sampling moments by sampling the real-time joint motion data and the real-time image data at a preset time interval; and
obtaining a learning data sample of the to-be-learned operation task by constructing a time series for the robot joint sampling data and the observation image sampling data of each of the sampling moments.

6. The method of claim 1, wherein obtaining the learning data sample in the task learning dataset for the to-be-learned operation task by processing the real-time joint motion data and the real-time image data that are related to the task execution operation comprises:
performing a calibration configuration on a coordinate system transformation relationship between the body workspace coordinate system of each of a plurality of movable body parts of the humanoid robot and the motion capture coordinate system of the inertial motion capturing device, and performing a strategy configuration on a smooth trajectory planning strategy of the movable body part.

7. A humanoid robot, comprising:
a camera;
a processor;
a memory coupled to the processor; and
one or more computer programs stored in the memory and executable on the processor;
wherein, the one or more computer programs comprise:
instructions for obtaining, during performing a to-be-learned operation task, real-time joint motion data of the humanoid robot, capturing, through the camera, real-time image data of a task target and a scene of the humanoid robot, and displaying the image data;
instructions for collecting, through an inertial motion capturing device, human body motion posture data for a human in real time, and converting the human body motion posture data into desired joint motion data adapted to the humanoid robot;
instructions for controlling, based on the real-time joint motion data, the humanoid robot to move according to the desired joint motion data, and returning to obtain the real-time joint motion data of the humanoid robot until the humanoid robot successfully completes a task execution operation for the task target; and
instructions for obtaining a learning data sample in a task learning dataset for the to-be-learned operation task by processing the real-time joint motion data and the real-time image data that are related to the task execution operation, wherein each learning data sample corresponds to each task execution operation of the to-be-learned operation task.

8. The humanoid robot of claim 7, wherein the inertial motion capturing device includes a plurality of inertial posture sensors respectively worn on different human skeletal parts of the human, and the human body motion posture data includes skeletal motion posture data collected by the inertial posture sensors in a motion capture coordinate system; and the instructions for converting the human body motion posture data into the desired joint motion data adapted to the humanoid robot comprise:
instructions for performing, based on the human skeleton data of the human, a human joint motion state estimation using the skeletal motion posture data of each of the inertial posture sensos in the motion capture coordinate system, and obtaining human joint motion data of the human in the motion capture coordinate system;
instructions for obtaining the desired joint motion data by mapping the human joint motion data in the motion capture coordinate system to a robot coordinate system of the humanoid robot.

9. The humanoid robot of claim 8, wherein the robot coordinate system of the humanoid robot includes a body workspace coordinate system of each of a plurality of movable body parts of the humanoid robot, and the desired joint motion data includes target joint motion data of the movable body part in the corresponding body workspace coordinate system; and the instructions for obtaining the desired joint motion data by mapping the human joint motion data in the motion capture coordinate system to a robot coordinate system of the humanoid robot comprise:
instructions for extracting, for each of the movable body parts, effective joint motion data corresponding to the movable body part from the human joint motion data; and
instructions for obtaining the target joint motion data of each of the movable body parts in the corresponding body workspace coordinate system by performing, based on a coordinate system transformation relationship between the motion capture coordinate system and the body workspace coordinate system of the movable body part, a coordinate system transformation on the effective joint motion data corresponding to the movable body part.

10. The humanoid robot of claim 9, wherein the real-time joint motion data includes actual joint motion data of each of the movable body parts in the corresponding body workspace coordinate system; and the instructions for controlling, based on the real-time joint motion data, the humanoid robot to move according to the desired joint motion data comprise:
instructions for selecting, for each of the movable body parts of the humanoid robot, a target planning strategy matching the movable body part from a plurality of preset smooth trajectory planning strategies for the movable body part;
instructions for obtaining an expected smooth motion trajectory of each of the movable body parts by performing, based on the actual joint motion data and the target joint motion data of the movable body part, a smooth motion trajectory planning according to the target planning strategy in the body workspace coordinate system of the movable body part; and
instructions for controlling, according the expected smooth motion trajectory, each of a plurality of robot joints included in each of the movable body parts to move.

11. The humanoid robot of claim 7, wherein the instructions for obtaining the learning data sample in the task learning dataset for the to-be-learned operation task by processing the real-time joint motion data and the real-time image data that are related to the task execution operation comprise:
instructions for obtaining robot joint sampling data and observation image sampling data of a plurality of sampling moments by sampling the real-time joint motion data and the real-time image data at a preset time interval; and
instructions for obtaining a learning data sample of the to-be-learned operation task by constructing a time series for the robot joint sampling data and the observation image sampling data of each of the sampling moments.

12. The humanoid robot of claim 7, wherein the instructions for obtaining the learning data sample in the task learning dataset for the to-be-learned operation task by processing the real-time joint motion data and the real-time image data that are related to the task execution operation comprise:
instructions for performing a calibration configuration on a coordinate system transformation relationship between the body workspace coordinate system of each of a plurality of movable body parts of the humanoid robot and the motion capture coordinate system of the inertial motion capturing device, and performing a strategy configuration on a smooth trajectory planning strategy of the movable body part.

13. A non-transitory computer-readable storage medium for storing one or more computer programs, wherein the one or more computer programs comprise:
instructions for obtaining, during performing a to-be-learned operation task, real-time joint motion data of a humanoid robot, capturing, through a camera of the humanoid robot, real-time image data of a task target and a scene of the humanoid robot, and displaying the image data;
instructions for collecting, through an inertial motion capturing device, human body motion posture data for a human in real time, and converting the human body motion posture data into desired joint motion data adapted to the humanoid robot;
instructions for controlling, based on the real-time joint motion data, the humanoid robot to move according to the desired joint motion data, and returning to obtain the real-time joint motion data of the humanoid robot until the humanoid robot successfully completes a task execution operation for the task target; and
instructions for obtaining a learning data sample in a task learning dataset for the to-be-learned operation task by processing the real-time joint motion data and the real-time image data that are related to the task execution operation, wherein each learning data sample corresponds to each task execution operation of the to-be-learned operation task.

14. The storage medium of claim 13, wherein the inertial motion capturing device includes a plurality of inertial posture sensors respectively worn on different human skeletal parts of the human, and the human body motion posture data includes skeletal motion posture data collected by the inertial posture sensors in a motion capture coordinate system; and the instructions for converting the human body motion posture data into the desired joint motion data adapted to the humanoid robot comprise:
instructions for performing, based on the human skeleton data of the human, a human joint motion state estimation using the skeletal motion posture data of each of the inertial posture sensos in the motion capture coordinate system, and obtaining human joint motion data of the human in the motion capture coordinate system;
instructions for obtaining the desired joint motion data by mapping the human joint motion data in the motion capture coordinate system to a robot coordinate system of the humanoid robot.

15. The storage medium of claim 14, wherein the robot coordinate system of the humanoid robot includes a body workspace coordinate system of each of a plurality of movable body parts of the humanoid robot, and the desired joint motion data includes target joint motion data of the movable body part in the corresponding body workspace coordinate system; and the instructions for obtaining the desired joint motion data by mapping the human joint motion data in the motion capture coordinate system to a robot coordinate system of the humanoid robot comprise:
instructions for extracting, for each of the movable body parts, effective joint motion data corresponding to the movable body part from the human joint motion data; and
instructions for obtaining the target joint motion data of each of the movable body parts in the corresponding body workspace coordinate system by performing, based on a coordinate system transformation relationship between the motion capture coordinate system and the body workspace coordinate system of the movable body part, a coordinate system transformation on the effective joint motion data corresponding to the movable body part.

16. The storage medium of claim 15, wherein the real-time joint motion data includes actual joint motion data of each of the movable body parts in the corresponding body workspace coordinate system; and the instructions for controlling, based on the real-time joint motion data, the humanoid robot to move according to the desired joint motion data comprise:
instructions for selecting, for each of the movable body parts of the humanoid robot, a target planning strategy matching the movable body part from a plurality of preset smooth trajectory planning strategies for the movable body part;
instructions for obtaining an expected smooth motion trajectory of each of the movable body parts by performing, based on the actual joint motion data and the target joint motion data of the movable body part, a smooth motion trajectory planning according to the target planning strategy in the body workspace coordinate system of the movable body part; and
instructions for controlling, according the expected smooth motion trajectory, each of a plurality of robot joints included in each of the movable body parts to move.

17. The storage medium of claim 13, wherein the instructions for obtaining the learning data sample in the task learning dataset for the to-be-learned operation task by processing the real-time joint motion data and the real-time image data that are related to the task execution operation comprise:
instructions for obtaining robot joint sampling data and observation image sampling data of a plurality of sampling moments by sampling the real-time joint motion data and the real-time image data at a preset time interval; and
instructions for obtaining a learning data sample of the to-be-learned operation task by constructing a time series for the robot joint sampling data and the observation image sampling data of each of the sampling moments.

18. The storage medium of claim 13, wherein the instructions for obtaining the learning data sample in the task learning dataset for the to-be-learned operation task by processing the real-time joint motion data and the real-time image data that are related to the task execution operation comprise:
instructions for performing a calibration configuration on a coordinate system transformation relationship between the body workspace coordinate system of each of a plurality of movable body parts of the humanoid robot and the motion capture coordinate system of the inertial motion capturing device, and performing a strategy configuration on a smooth trajectory planning strategy of the movable body part.
